(19) United States
(12) Patent Application Publication
(10) Pub. No.: US 2026/0184326 A1
(43) Pub. Date: Jul. 2, 2026

(54) WARNING METHOD AND WARNING SYSTEM FOR VEHICLE DRIVING

(71) Applicant: Wistron Corporation, New Taipei City (TW)

(72) Inventors: Shang Jyun Heng, New Taipei City (TW); Chih Hao Chiu, New Taipei City (TW); Chien Hua Chen, New Taipei City (TW); Hao Gong Chou, New Taipei City (TW)

(73) Assignee: Wistron Corporation, New Taipei City (TW)

(21) Appl. No.: 19/054,911

(22) Filed: Feb. 17, 2025

(30) Foreign Application Priority Data
Dec. 30, 2024 (TW) 113151430

(51) Int. Cl. B60W 50/14; B60K 35/23; B60K 35/28

(52) U.S. Cl. CPC B60W 50/14; B60K 35/23; B60K 35/28; B60K 2360/178; B60K 2360/1868; B60K 2360/785; B60W 2050/146; B60W 2554/4045; B60W 2554/4046; B60W 2554/80

(57) ABSTRACT

Provided are a warning method and a warning system for vehicle driving. Vehicle information is obtained. The vehicle information is converted into one or more vehicle characteristics. Statistical values corresponding to the vehicle characteristics are determined. Warning information is generated based on the statistical values. The vehicle information is obtained by detecting neighboring vehicles surrounding the vehicle. The vehicle characteristics represent a relative relationship between the vehicle and the neighboring vehicles. The statistical values are accumulated in response to vehicle characteristics meeting corresponding hazard conditions. The warning information is used to indicate the relative relationship between the vehicle and the neighboring vehicles. Therefore, the driving safety can be improved.

### CROSS-REFERENCE TO RELATED APPLICATION

This application claims the priority benefit of Taiwan application serial no. 113151430, filed on Dec. 30, 2024. The entirety of the above-mentioned patent application is hereby incorporated by reference herein and made a part of this specification.

### BACKGROUND

### Technical Field

The disclosure relates to a safety protection technology, and particularly relates to a warning method and a warning system for vehicle driving.

### Related Art

In recent years, advanced driver assistance systems (ADAS) have developed rapidly. ADAS aims to improve driving safety by assisting drivers through technology to reduce the occurrence of traffic accidents. Existing ADAS technologies mainly focus on detecting the driving behavior of one's own vehicle, such as fatigue driving and lane departure, and issue warnings accordingly. However, for the detection of driving behaviors and intentions of surrounding vehicles, there is still a lack of relevant technological development.

### SUMMARY

The disclosure provides a warning method and a warning system for vehicle driving, which can detect the driving behaviors and intentions of surrounding vehicles.

The warning method for vehicle driving according to an embodiment of the disclosure includes (but is not limited to) the following steps. Vehicle information is obtained. The vehicle information is converted into one or more vehicle characteristics. Statistical values corresponding to the vehicle characteristics are determined. Also, warning information is generated based on the statistical values. The vehicle information is obtained by detecting neighboring vehicles surrounding the vehicle. The vehicle characteristics represent a relative relationship between the vehicle and the neighboring vehicles. The statistical values are accumulated in response to vehicle characteristics meeting corresponding hazard conditions. The warning information is used to indicate the relative relationship between the vehicle and the neighboring vehicles.

The warning system for vehicle driving according to an embodiment of the disclosure includes a storage device and a processor. The storage device stores a program code. The processor is coupled to the storage device, loads the program code, and executes the following operations. Vehicle information is obtained. The vehicle information is converted into one or more vehicle characteristics. Statistical values corresponding to the vehicle characteristics are determined. Also, warning information is generated based on the statistical values. The vehicle information is obtained by detecting neighboring vehicles surrounding the vehicle. The vehicle characteristics represent a relative relationship between the vehicle and the neighboring vehicles. The statistical values are accumulated in response to vehicle characteristics meeting corresponding hazard conditions. The warning information is used to indicate the relative relationship between the vehicle and the neighboring vehicles.

Based on the above, the warning method and the warning system for vehicle driving according to embodiments of the disclosure may determine the statistical values of the vehicle characteristics obtained from monitoring the neighboring vehicles meeting the hazard conditions, and generate the warning information corresponding to the statistical values. In this way, through accumulating statistics meeting the conditions, the actual relationship between the vehicle and the neighboring vehicles can be inferred, thereby the driving safety is improved.

To make the foregoing features and advantages of the disclosure more comprehensible, embodiments are described below with detailed explanations together with the accompanying drawings.

### BRIEF DESCRIPTION OF THE DRAWINGS

FIG. 1 is a component block diagram of a warning system for vehicle driving according to an embodiment of the disclosure.

FIG. 2 is a flowchart of a warning method for vehicle driving according to an embodiment of the disclosure.

FIG. 3 is a schematic diagram illustrating the relationship between information according to an embodiment of the disclosure.

FIG. 4 is a schematic diagram illustrating conditions of lane crossing and within the lane according to an embodiment of the disclosure.

FIG. 5 is a schematic diagram illustrating lane changing according to an embodiment of the disclosure.

FIG. 6A is a schematic diagram illustrating fuzzy rules corresponding to the lane crossing ratio according to an embodiment of the disclosure.

FIG. 6B is a schematic diagram illustrating fuzzy rules corresponding to the lane crossing change ratio according to an embodiment of the disclosure.

FIG. 6C is a schematic diagram illustrating fuzzy rules corresponding to the speed standard deviation according to an embodiment of the disclosure.

FIG. 6D is a schematic diagram illustrating fuzzy rules corresponding to the close distance ratio according to an embodiment of the disclosure.

FIG. 7 is a schematic diagram illustrating a membership function according to an embodiment of the disclosure.

FIG. 8 is a schematic diagram illustrating a warning image for continuous lane changing according to an embodiment of the disclosure.

FIG. 9 is a schematic diagram illustrating a warning image for continuous lane changing according to an embodiment of the disclosure.

### DESCRIPTION OF THE EMBODIMENTS

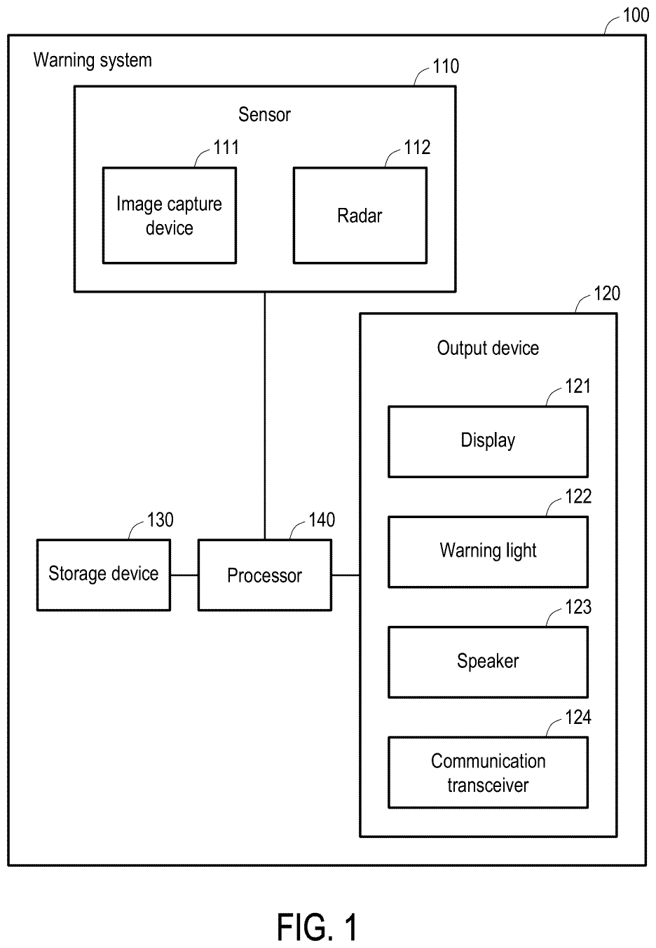

FIG. 1 is a component block diagram of a warning system for vehicle driving according to an embodiment of the disclosure. Referring to FIG. 1, a warning system 100 includes (but is not limited to) a sensor 110, an output device 120, a storage device 130, and a processor 140. It should be noted that each component or device shown in FIG. 1 is merely exemplified by one, but the actual application is not limited to the quantity shown in FIG. 1.

The warning system 100 is installed in a vehicle. The vehicle may be a bicycle, motorcycle, car, truck, bus, or other types of vehicle, but the disclosure is not limited thereto. In an embodiment, the warning system 100 may be an on-board system, a driver assistance system, or other vehicle systems. In another embodiment, the warning system 100 may be a smartphone, a tablet computer, a wearable device, a smart assistant device, or other devices.

The sensor 110 is used to obtain sensing data. The sensing data may include, for example, images, distances, speeds, accelerations, and/or orientations.

In an embodiment, the sensor 110 includes an image capture device 111. The image capture device 111 may be a camera, a video camera, a dash cam, or other devices with image capture functionality. In an embodiment, the image capture device 111 is used to capture images within a specific field of view and generate captured images accordingly. For example, the image capture device 111 may be installed at the front and rear of the vehicle, and used to capture surrounding images within the field of view in front of and behind the vehicle, respectively. As another example, the image capture device 111 may be installed on the left and right rearview mirrors, and used to capture surrounding images within the field of view to the left and right of the vehicle, respectively. However, the installation position and field of view specifications of the image capture device 111 may still be adjusted according to actual needs.

In an embodiment, the sensor 110 includes a radar 112. The radar 112 may be an electromagnetic wave radar, a lidar, a depth sensor, a Time of Flight (ToF) sensor, or a stereo camera. In an embodiment, the radar 112 is used to detect the distance (hereinafter referred to as vehicle distance) between the vehicle (installed with the radar 112) and one or more other vehicles (hereinafter referred to as neighboring vehicles).

In an embodiment, the sensor 110 includes both the image capture device 111 and the radar 112.

The output device 120 is used to present warning information. The warning information will be described in detail in subsequent embodiments.

In an embodiment, the output device 120 includes a display 121. The display 121 may be a head-up display or other video playback equipment using projection display technology. Alternatively, the display 121 may be a liquid-crystal display (LCD), light emitting diode (LED) display, organic light emitting diode (OLED) display, or mini LED display. In an embodiment, the display 121 is used to project or display one or more images.

In an embodiment, the output device 120 includes a warning light 122. The warning light 122 may be, for example, a hazard lights, a turn signal, or other light sources of the vehicle. In an embodiment, the warning light 122 is used to emit light of specific or non-specific colors, frequencies, and/or intensities.

In an embodiment, the output device 120 includes a speaker 123. The speaker 123 may be, for example, the speaker or loudspeaker of the vehicle. In an embodiment, the speaker is used to emit sound.

In an embodiment, the output device 120 includes a communication transceiver 124. The communication transceiver 124 may be a transceiver circuit supporting mobile communication, Wi-Fi, Bluetooth, or other communication protocols. In an embodiment, the communication transceiver 124 is used to transmit or receive data.

In an embodiment, the output device 120 includes at least two of the display 121, the warning light 122, the speaker 123, and the communication transceiver 124.

The storage device 130 may be any type of fixed or removable random access memory (RAM), read only memory (ROM), flash memory, hard disk drive (HDD), solid state drive (SSD), or similar components. In an embodiment, the storage device 130 is used to store program codes, software modules, configurations, data (for example, vehicle information, vehicle characteristics, statistical values, or warning information) or files, which will be described in detail in subsequent embodiments.

The processor 140 is coupled to the sensor 110, the output device 120, and the storage device 130. The processor 140 may be a central processing unit (CPU), a graphic processing unit (GPU), or other programmable general-purpose or special-purpose microprocessors, a digital signal processor (DSP), a programmable controller, a field programmable gate array (FPGA), an application specific integrated circuit (ASIC), a neural network accelerator, or other similar components or a combination of the above components. In an embodiment, the processor 140 is used to execute all or part of the operations of the warning system 100, and may load and execute various program codes, software modules, files, and data stored in the storage device 130.

In the following, the method described in the embodiments of the disclosure will be explained in conjunction with various devices, components, and modules in the warning system 100. The processes of this method may be adjusted according to the implementation circumstances and are not limited to this description.

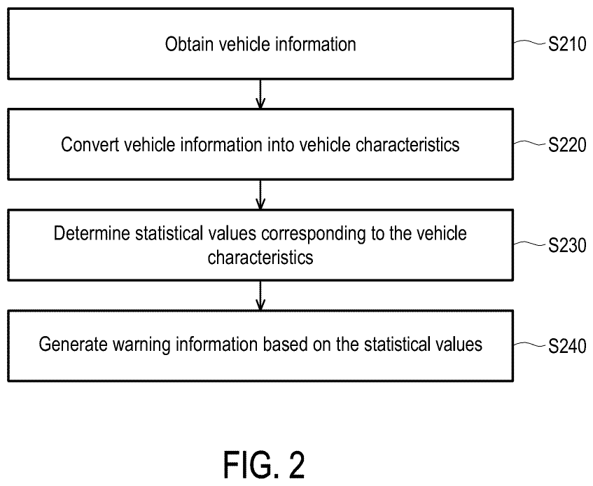

FIG. 2 is a flowchart of a warning method for vehicle driving according to an embodiment of the disclosure. Referring to FIG. 2, the processor 140 obtains vehicle information (Step S210). Specifically, the vehicle information is obtained by the sensor 110 detecting neighboring vehicles surrounding the vehicle (the vehicle is installed with the sensor 110 or the sensor 110 is on the vehicle). Depending on the detection range of the sensor 110, the sensor 110 may detect neighboring vehicles within a certain distance. In other words, other vehicles that can be detected by the sensor 110 are considered as the neighboring vehicles. In some embodiments, the definition of the neighboring vehicle may further be related to vehicle distance, orientation, vehicle type, or other conditions, and may be adjusted according to the needs of the user.

In an embodiment, the vehicle information includes the relative speed, acceleration, and/or orientation of the neighboring vehicles with respect to the vehicle installed with the warning system 100. In an embodiment, the processor 140 may calculate the relative speed, acceleration, and/or orientation corresponding to the sensing data (for example, round-trip time and sensing intensity) of the radar 112 using distance measurement-related algorithms.

In an embodiment, the vehicle information includes positions of the neighboring vehicles relative to lane lines. For example, the lane in which a neighboring vehicle is located and/or the position of the neighboring vehicle within the lane. In an embodiment, the processor 140 may use object detection techniques (for example, image recognition based on machine learning algorithms, object matching based on image features) to identify neighboring vehicles, lane lines, and the positions thereof, and determine whether the neighboring vehicle is (completely) within the lane (that is, within the lane line) or whether the neighboring vehicle is on the lane line (that is, crossing the lane line).

The processor 140 converts the vehicle information into one or more vehicle characteristics (Step S220). Specifically, the vehicle characteristics represent the relative relationship between the vehicle and the neighboring vehicles. The relative relationship may be relative position, orientation, relative speed, and/or acceleration, and may further be the relative position and/or direction among the vehicle, the neighboring vehicles, and the lane lines.

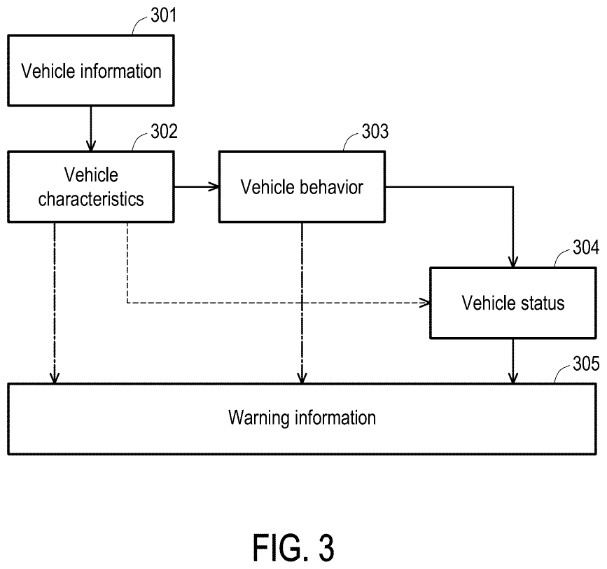

FIG. 3 is a schematic diagram illustrating the relationship between information according to an embodiment of the disclosure. Referring to FIG. 3, vehicle characteristics 302 are based on vehicle information 301.

In an embodiment, the vehicle characteristic is a vehicle orientation. The vehicle orientation is used to indicate the relative position of the surrounding vehicles (that is, the neighboring vehicles) with respect to the driving vehicle. For example, whether the neighboring vehicles are in front of or behind the vehicle.

In an embodiment, the vehicle characteristic is a lane position. The lane position is used to indicate whether the surrounding vehicle (that is, the neighboring vehicle) is currently in a status of lane crossing. That is, whether the neighboring vehicle is on the lane line. Being on the lane line is referred to as “lane-crossing state”, while not being/not yet being on the lane line is referred to as “within lane state”.

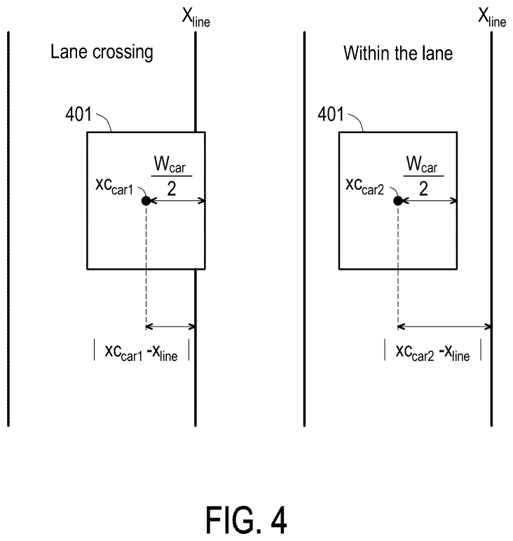

For example, FIG. 4 is a schematic diagram illustrating conditions of lane crossing and within the lane according to an embodiment of the disclosure. Referring to FIG. 4, a width W_{car} of a neighboring vehicle 401 in the front or rear is used as a lane crossing standard. If the distance between a center point XC_{car1} of the neighboring vehicle 401 and a lane line Xₗᵢₙₑ is within the lane crossing standard, then it is determined to be in a “lane-crossing state”:

$$\vert {XC}_{car 1} - {X}_{line} \vert < {W}_{car} / 2. \qquad ( 1 )$$

On the other hand, “within lane state” is the status excluding the “lane-crossing state”. If the distance between the center point XC car 2 of the neighboring vehicle 401 and the lane line X line is greater than or equal to the lane crossing standard, it is determined to be in a “within lane state”:

$$\vert {XC}_{car 2} - {X}_{line} \vert \geq {W}_{car} / 2. \qquad ( 2 )$$

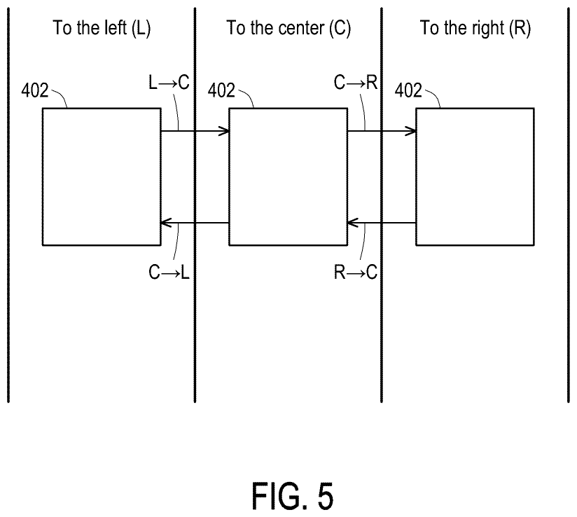

In an embodiment, the vehicle characteristic is a current lane. The current lane is used to indicate which lane the surrounding vehicle (that is, the neighboring vehicle) is in relative to the lane of the current driving vehicle. For example, FIG. 5 is a schematic diagram illustrating lane changing according to an embodiment of the disclosure. Referring to FIG. 5, assuming the current driving vehicle is in a center lane C, the lane to the left of the center lane C is a left lane L, and the lane to the right of the center lane C is a right lane R.

In an embodiment, the vehicle characteristic is position change, for example, crossing the lane line. There are four scenarios for position change: changing from the left lane L to the center lane C, changing from the center lane C to the left lane L, changing from the right lane R to the center lane C, and changing from the center lane C to the right lane R.

The processor 140 may compare whether the lane position ((POSₚᵣₑᵥ) in the previous frame of multiple images captured by the image capture device 111 is the same as the lane position ((Pos_{cur}) in the current frame, so as to determine if the lane position of the neighboring vehicle 402 is changed (that is, crossed the lane line). For example:

$$If {Pos}_{prev} \neq {Pos}_{cur} , then the lane position is changed ;$$

$$if {Pos}_{prev} = {Pos}_{cur} , then the lane position is not changed .$$

In an embodiment, the vehicle characteristic is a vehicle distance state. The vehicle distance state is used to indicate whether the surrounding vehicle (that is, the neighboring vehicle) maintain a safe distance range from the driving vehicle. For example, regulations for cars driving on highways and expressways specify the following rules for safe driving distances between two vehicles in normal weather conditions:

For small vehicles: the value obtained by dividing the vehicle speed in kilometers per hour by two, with the unit being meters.

For large vehicles: the value obtained by subtracting twenty from the vehicle speed in kilometers per hour, with the unit being meters.

The vehicle distance state includes a close distance state. The processor 140 may determine the safe distance range based on a target vehicle speed (V_{car}). If the vehicle distance (D_{car}) between the front and rear vehicles is within the safe distance range, then it is determined to be in a “close distance state”:

$$For small vehicles : {D}_{car} < {V}_{car} / 2 ;$$

$$for large vehicles : {D}_{car} < {V}_{car} - 20.$$

The processor 140 may determine the safe distance range based on the target vehicle speed (V_{car}). If the vehicle distance (D_{car}) between the front and rear vehicles exceeds the safe distance range, then it is determined that the neighboring vehicle maintains a safe distance and is in a “safe distance state”:

$$For small vehicles : {D}_{car} \geq {V}_{car} / 2 ;$$

$$for large vehicles : {D}_{car} \geq {V}_{car} - 20.$$

In some application scenarios, the sensor data from the radar 112 may determine the relative speed or directly provide the relative speed. The processor 140 may use the speed (V_{curr}) of the current driving vehicle and the relative vehicle speed (Vr_{car}) to determine the target vehicle speed (V_{car}):

V_{car}=V_{curr}+Vr_{car}. That is, the calculated result is the sum of the relative vehicle speed Vr_{car} and the speed V_{curr} of the current driving vehicle.

In an embodiment, the vehicle characteristics include a speed change state (Acc_{car}). The speed change state is used to indicate the speed increase or decrease state of the surrounding vehicle (that is, the neighboring vehicle). The processor 140 may define a range threshold T_{acc} to allow changes in the speed change state ACC_{car} within a specified range while still maintaining a stable state:

$$stable state :$$

$${Acc}_{car} = {T}_{acc} ;$$

$$acceleration state :$$

$${Acc}_{car} > {T}_{acc} ;$$

$$deacceleration state :$$

$${Acc}_{car} < - {T}_{acc} .$$

In an embodiment, the vehicle characteristics include the relative speed (Vr_{car}). The relative speed is used to indicate the relative speed of the surrounding vehicle (that is, the neighboring vehicle) relative to the current driving vehicle, and is used to represent whether the speed difference is too large. The processor 140 may define a range threshold Tᵥᵣ to allow changes in the relative speed Vr_{car} within a specified range while still maintaining a state of relative constant speed:

$$relative low speed state :$$

$${Vr}_{car} < {T}_{vr} ;$$

$$relative constant speed state :$$

$${Vr}_{car} = {T}_{vr} ;$$

$$relative high speed state :$$

$${Vr}_{car} > - {T}_{vr} .$$

Referring to FIG. 2, the processor 140 determines statistical values corresponding to the one or more vehicle characteristics (Step S230). Specifically, the statistical values are accumulated in response to vehicle characteristics meeting corresponding hazard conditions. In other words, the statistical values are the accumulated count of vehicle characteristics meeting the corresponding hazard conditions. Referring to FIG. 3, based on the vehicle information 301 and the classified vehicle characteristics 302, the processor 140 may further perform statistical processing on the information. For example, statistical analysis may be performed on information within a specified period.

In an embodiment, the processor 140 may count the number of times the vehicle characteristics meeting the corresponding hazard conditions at multiple observation time points. The multiple observation time points are within a specified period (for example, 1 minute, 30 seconds, or 10 seconds). A ratio of the number of times to the multiple observation time points may serve as the statistical value corresponding to the vehicle characteristic. The observation time points may correspond to detection time points of the sensor 110. For example, at a certain observation time point, the image capture device 111 obtains one frame of captured image. Assuming the frames per second (FPS) of the image capture device 111 is 10, then it means there are 10 frames of captured images per second, which also means there are 10 observation/detection time points per second.

In an embodiment, the hazard conditions may include at least one of the neighboring vehicle being on the road line, the neighboring vehicle being not on the road line, the neighboring vehicle crossing the road line, the neighboring vehicle being within the safe distance range, the neighboring vehicle being outside the safe distance range, and the difference between the target speed (that is, the sum of the relative speed and the speed of the current driving vehicle) corresponding to the neighboring vehicle and the average speed.

Some examples are as follows.

Lane crossing ratio within N seconds (that is, the ratio of the neighboring vehicle being on the road line at the multiple observation time points):

$$Lane crossing ratio = \frac{lane crossing times}{N \times M} ,$$

where N is the number of seconds, M is the number of the one or more observation time points per second for the sensor 110, N×M is the total number of the multiple observation time points, and the lane crossing times is the number of times the neighboring vehicle is on the road line at the observation time points. Within lane ratio within N seconds (that is, the ratio of the neighboring vehicle not being on the road line at the multiple observation time points):

$$within lane ratio = 1 - \frac{lane crossing times}{N \times M} ,$$

which is, 1-lane crossing ratio.
The ratio of lane crossing change ratio within N seconds (that is, the ratio of the neighboring vehicle switching to “lane-crossing state” or crossing the road line at the multiple observation time points):

$$lane crossing change ratio = \frac{lane crossing change times}{N \times M} ,$$

where lane crossing change times is the number of times the neighboring vehicle switching to “lane-crossing state” or the number of times crossing the road line at the observation time points. The processor 140 may determine that the lane position LinePositionₚᵣₑᵥ in the previous frame of the multiple captured images obtained by the image capture device 111 is “within lane state” while the lane position LinePosition_{curr} in the current frame is “lane-crossing state OnRoadLine”, and accumulate the lane crossing change times accordingly:

$${LinePosition}_{prev} \neq {LinePosition}_{curr} and {LinePosiiton}_{curr} = OnRoadLine .$$

Close distance ratio within N seconds (that is, the ratio of the vehicle distance between the neighboring vehicle and the driving vehicle being in “close distance state” (that is, outside the safe distance range) at the multiple observation time points):

$$close distance ratio = \frac{close distance times}{N \times M} ,$$

where close distance times is the number of times the vehicle distance between the neighboring vehicle and the driving vehicle being in “close distance state” at the observation time points.
Safe distance ratio within N seconds (that is, the ratio of the vehicle distance between the neighboring vehicle and the driving vehicle being in “safe distance state” (that is, within the safe distance range) at the multiple observation time points):

$$safe distance ratio = 1 - \frac{close distance times}{N \times M} ,$$

which is, 1-close distance ratio.
Speed standard deviation ((V_{σ}) within N seconds (that is, the standard deviation of a target vehicle speed corresponding to an average speed at the multiple observation time points):

$${V}_{σ} = \sqrt{\frac{1}{N \times N} {\sum }_{i = 1}^{N \times M} {( {V}_{i} - μ )}^{2}} ,$$

where Vᵢ represents the target vehicle speed at the i-th observation time point, and μ represents the average speed (that is, the average vehicle speed) within N seconds.

Referring to FIG. 2, the processor 140 generates warning information based on the statistical values (Step S240). Specifically, the warning information is used to indicate the relative relationship between the vehicle and the neighboring vehicles. The relative relationship is further related to the statistical values. The statistical values help to understand the driving intentions of the neighboring vehicles.

In an embodiment, the processor 140 may determine vehicle behavior information of the neighboring vehicle based on the statistical values. Referring to FIG. 3, the statistical values based on the vehicle characteristics 302 may be used to generate vehicle behavior information 303. The vehicle behavior information includes at least one of multiple behavior levels corresponding to the hazard conditions. For example, the behavior levels include mild, moderate, and high, which correspond to low, medium, and high degrees of hazard, respectively.

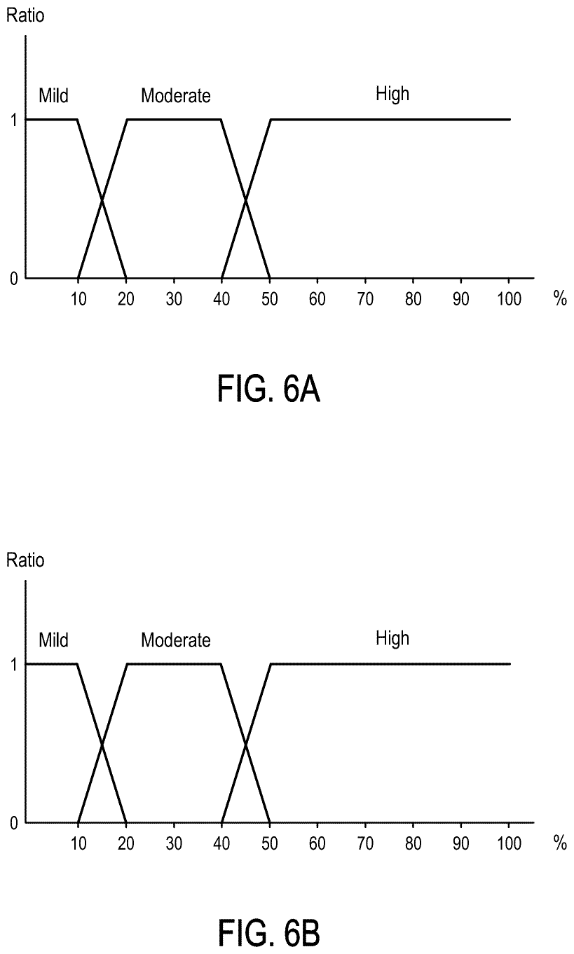

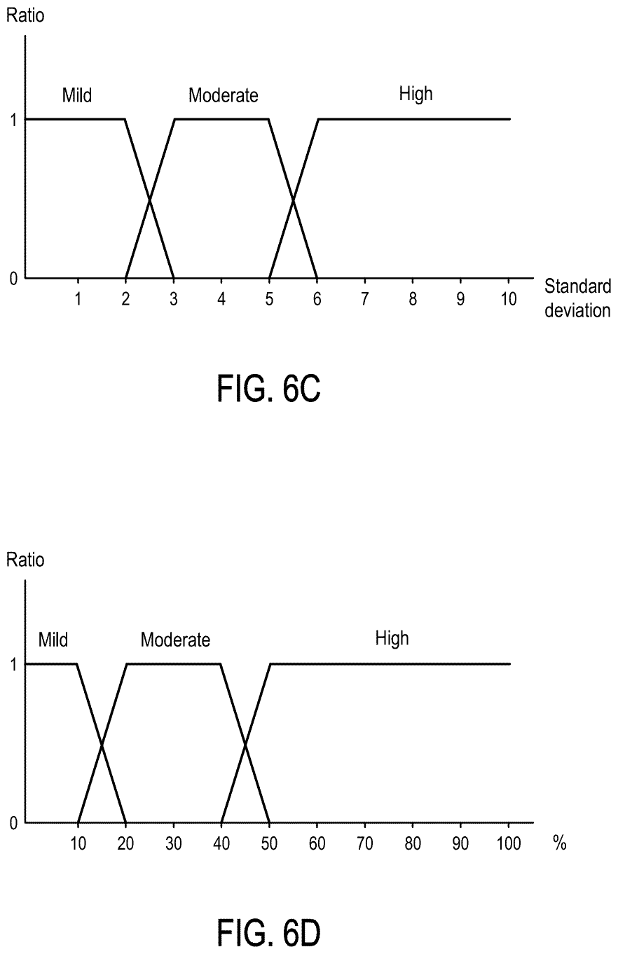

In an embodiment, the processor 140 may use fuzzy rules and sets on the statistical values to determine the vehicle behavior information. For example, FIG. 6A is a schematic diagram illustrating fuzzy rules corresponding to the lane crossing ratio according to an embodiment of the disclosure. Please refer to FIG. 6A, which shows membership functions corresponding to the fuzzy rules. The membership functions define the behavior levels corresponding to the statistical values. When the lane crossing ratio is between 0-20, the corresponding behavior level is mild. For example, the vehicle behavior information of the neighboring vehicle may be considered as driving within the lane. When the lane crossing ratio is between 10-50, the corresponding behavior level is moderate. For example, the vehicle behavior information of the neighboring vehicle may be considered as slight lane crossing. When the lane crossing ratio is between 40-100, the corresponding behavior level is high. For example, the vehicle behavior information of the neighboring vehicle may be considered as severe lane crossing.

FIG. 6B is a schematic diagram illustrating fuzzy rules corresponding to the lane crossing change ratio according to an embodiment of the disclosure. Please refer to FIG. 6B, which shows the membership functions corresponding to the fuzzy rules. When the lane crossing change ratio is between 0-20, the corresponding behavior level is mild. For example, the vehicle behavior information of the neighboring vehicle may be considered as centered driving. When the lane crossing change ratio is between 10-50, the corresponding behavior level is moderate. For example, the vehicle behavior information of the neighboring vehicle may be considered as swaying left and right. When the lane crossing change ratio is between 40-100, the corresponding behavior level is high. For example, the vehicle behavior information of the neighboring vehicle may be considered as continuous change of driving path. Moreover, for the overlapping parts of the two behavior levels shown in the drawing (for example, ratio between 10-20 or between 40-50), the processor 140 may determine the degree of membership or proportion of the ratio corresponding to the two behavior levels through the membership function.

FIG. 6C is a schematic diagram illustrating fuzzy rules corresponding to the speed standard deviation according to an embodiment of the disclosure. Please refer to FIG. 6C. When the speed standard deviation is between 0-3, the corresponding behavior level is mild. For example, the vehicle behavior information of the neighboring vehicle may be considered as smooth driving. When the speed standard deviation is between 2-6, the corresponding behavior level is moderate. For example, the vehicle behavior information of the neighboring vehicle may be considered as speed fluctuating between fast and slow. When the speed standard deviation is above 5, the corresponding behavior level is high. For example, the vehicle behavior information of the neighboring vehicle may be considered as drastic speed changes.

FIG. 6D is a schematic diagram illustrating fuzzy rules corresponding to the close distance ratio according to an embodiment of the disclosure. Please refer to FIG. 6D, which shows the membership functions corresponding to the fuzzy rules. When the close distance ratio is between 0-20, the corresponding behavior level is mild. For example, the vehicle behavior information of the neighboring vehicle may be considered as good vehicle distance. When the close distance ratio is between 10-50, the corresponding behavior level is moderate. For example, the vehicle behavior information of the neighboring vehicle may be considered as unsafe vehicle distance. When the close distance ratio is between 40-100, the corresponding behavior level is high. For example, the vehicle behavior information of the neighboring vehicle may be considered as dangerous vehicle distance.

The processor 140 may determine corresponding warning information based on the vehicle characteristic and the behavior level (for example, a first level among multiple behavior levels, and the first level may be mild, moderate, or high) corresponding to the vehicle behavior information. Specifically, the vehicle characteristic and the corresponding vehicle behavior information may be used to determine potential hazardous vehicle conditions of the neighboring vehicle. In an embodiment, the warning information includes vehicle status information. Referring to FIG. 3, the vehicle characteristic 302 and the vehicle behavior information 303 may be used to determine vehicle status information 304. The vehicle status information is used to indicate hazardous vehicle conditions of the neighboring vehicle. The vehicle status information may include at least one of tailgating, high-speed approaching, sudden deceleration, speed fluctuation, continuous change of driving path, lane crossing driving, close distance lane changing, and path fluctuation.

The processor 140 may determine the vehicle status information of the neighboring vehicle based on the vehicle characteristic and the behavior level corresponding to the vehicle behavior information. For example, the corresponding relationships among the vehicle characteristics, the vehicle behavior information, and the vehicle status information are as follows. When the vehicle orientation is vehicle behind, the vehicle is in the center lane, the vehicle distance state is close distance state, and the close distance ratio indicates dangerous vehicle distance (that is, high), the vehicle status information is tailgating.

When the vehicle orientation is vehicle behind, the vehicle distance state is close distance state, and the speed is in a relative high speed state, the vehicle status information is high-speed approaching.

When the vehicle orientation is vehicle ahead, the vehicle is in the center lane, the vehicle distance state is close distance state, the acceleration state is deceleration state, and the speed standard deviation indicates drastic speed changes (that is, high), the vehicle status information is first sudden deceleration or sudden stop.

When the vehicle orientation is vehicle ahead, the vehicle is in the center lane, the vehicle distance state is close distance state, the acceleration state is deceleration state, and the relative speed is in a relatively low speed state, the vehicle status information is second sudden deceleration or sudden stop.

When the speed standard deviation indicates speed fluctuating between fast and slow (that is, moderate), the vehicle status information is speed fluctuation.

When the vehicle orientation is vehicle ahead, the vehicle is in the center lane, and the relative speed is in a relatively low speed state, the vehicle status information is crawling speed or congestion.

When the vehicle orientation is vehicle ahead, the vehicle is in the center lane, the lane crossing ratio indicates slight lane crossing (that is, mild), and the lane crossing change ratio indicates continuous change of driving path (that is, high), the vehicle status information is continuous change of driving path.

When the vehicle orientation is vehicle ahead, the lane position is in a lane-crossing state, and the lane crossing ratio indicates severe lane crossing (that is, high), the vehicle status information is driving while crossing lane lines.

When the vehicle orientation is vehicle ahead, the vehicle is in a position change state, and the vehicle distance state is close distance state, the vehicle status information is first close distance lane changing.

When the vehicle orientation is vehicle ahead, the vehicle is in a position change state, and the close distance ratio indicates dangerous vehicle distance (that is, high), the vehicle status information is second close distance lane changing.

When the vehicle orientation is vehicle ahead, the lane position is in a lane-crossing state, and the vehicle distance state is close distance state, the vehicle status information is third close distance lane changing.

When the vehicle orientation is vehicle ahead, the lane position is in a lane-crossing state, and the close distance ratio indicates dangerous vehicle distance (that is, high), the vehicle status information is fourth close distance lane changing.

When the vehicle orientation is vehicle ahead, the lane crossing ratio indicates slight lane crossing (that is, mild), and the lane crossing change ratio indicates swaying left and right (that is, moderate), the vehicle status information is path fluctuation.

In an embodiment, the warning information includes behavioral intention information. Referring to FIG. 3, the vehicle characteristic 302, the vehicle behavior information 303, and the vehicle status information 304 may be used to determine the behavioral intention information (that is, warning information 305) of the neighboring vehicle. In an embodiment, the behavioral intention information includes at least one of forcing front vehicle behavioral intention and forcing rear vehicle behavioral intention. “Forcing front vehicle behavioral intention” is, for example, when the rear vehicle has an intention to pressure the vehicle ahead. “Forcing rear vehicle behavioral intention” is, for example, when the vehicle ahead has a dangerous behavior of sudden deceleration.

In an embodiment, the relative relationship between the current driving vehicle and the neighboring vehicle includes vehicle distance. The processor 140 may determine the behavioral intention information of the neighboring vehicle based on the vehicle distance characteristic in the vehicle characteristic and the vehicle status information of the neighboring vehicle. The vehicle behavior information (such as the vehicle behavior information for close distance ratio) corresponding to the vehicle distance characteristic indicates the behavior intensity of the vehicle distance. For example, Table (1) shows the corresponding relationship among the vehicle behavior information corresponding to the vehicle characteristics, the vehicle status information, and the behavioral intention information for tailgating.

TABLE 1

| Behavioral | Vehicle | | | |
|---|---|---|---|---|
| intention | behavior | Vehicle status | Vehicle status | |
| information | information | information | information | Description |
| First forcing | Unsafe vehicle | Tailgating | | The vehicle behind |
| front vehicle | distance/danger | driving from | | drives at a close |
| behavioral | ous vehicle | vehicle behind | | distance for a long |
| intention | distance | | | time. |
| Second forcing | Unsafe vehicle | Speed | | The vehicle behind |
| front vehicle | distance/danger | fluctuation of | | drives at speeds |
| behavioral | ous vehicle | the vehicle | | fluctuating |
| intention | distance | behind | | between fast and |
| | | | | slow, in a |
| | | | | dangerous |
| | | | | situation with |
| | | | | unsafe vehicle |
| | | | | distance. |
| First forcing | Unsafe vehicle | Sudden | | The vehicle ahead |
| rear vehicle | distance/danger | deceleration of | | shows sudden |
| behavioral | ous vehicle | the vehicle | | deceleration while |
| intention | distance | ahead | | maintaining a |
| | | | | close distance with |
| | | | | the vehicle behind. |
| Second forcing | Unsafe vehicle | Lane changing | Sudden | The vehicle ahead |
| rear vehicle | distance/danger | of the vehicle | deceleration of | shows sudden |
| behavioral | ous vehicle | ahead | the vehicle | deceleration after |
| intention | distance | | ahead | overtaking. |
| Third forcing | Unsafe vehicle | Speed | Sudden | Unpredictable path |
| rear vehicle | distance/danger | fluctuation of | deceleration of | fluctuation of the |
| behavioral | ous vehicle | the vehicle | the vehicle | vehicle ahead, with |
| intention | distance | ahead | ahead | sudden |
| | | | | deceleration |
| | | | | occurring. |
| Fourth forcing | Unsafe vehicle | Continuous | Sudden | The vehicle ahead |
| rear vehicle | distance/danger | change of | deceleration of | shows signs of |
| behavioral | ous vehicle | driving path of | the vehicle | swerving behavior, |
| intention | distance | the vehicle | ahead | with sudden |
| | | ahead | | deceleration |
| | | | | occurring. |

In an embodiment, for behavioral intention information related to drunk driving or distracted driving, the driver may exhibit unstable behavior. For example, the vehicle behavior information indicates erratic path swaying left and right and/or speed fluctuating between fast and slow.

In an embodiment, the warning information includes instability information. The processor 140 may determine the instability information of the neighboring vehicle based on the behavior levels of multiple pieces of vehicle behavior information. The instability information includes multiple warning levels. That is, the behavior levels of the multiple pieces of vehicle behavior information may be further used to determine one of the multiple warning levels. Since the vehicle behavior information corresponds to multiple different types of statistical values, comprehensively considering the multiple types of statistical values helps to understand whether the behavior of the neighboring vehicle is unstable. For example, the neighboring vehicle may correspond to multiple types of vehicle behavior information within a certain time interval.

In an embodiment, the processor 140 may convert the behavior levels of the multiple pieces of vehicle behavior information into fuzzy values of behavior levels of the multiple pieces of vehicle behavior information through corresponding membership functions. As illustrated in FIG. 6A to FIG. 6D, the membership function in each drawing matches a fuzzy rule of each piece of the vehicle behavior information. For example, the membership function in FIG. 6A is for the fuzzy rule of lane crossing ratio, the membership function in FIG. 6B is for the fuzzy rule of lane crossing change ratio, the membership function in FIG. 6C is for the fuzzy rule of speed standard deviation, and the membership function in FIG. 6D is for the fuzzy rule of close distance ratio.

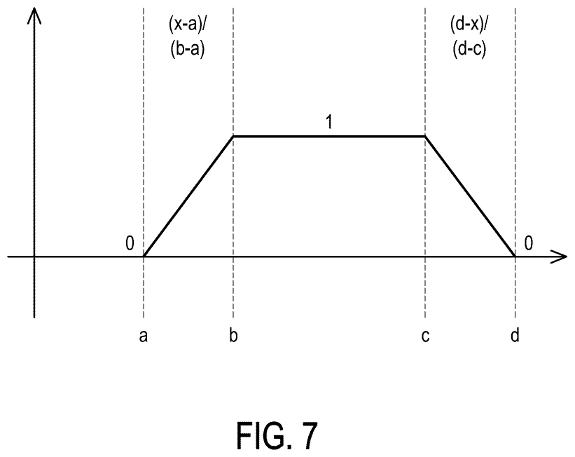

The fuzzy values are defined by membership functions as memberships or ratios for multiple behavior levels. For example, FIG. 7 is a schematic diagram illustrating a membership function according to an embodiment of the disclosure. Referring to FIG. 7, taking a trapezoidal membership function (f_{trapezoidal}) as an example (but not limited thereto):

$${f}_{trapezoidal} ( x : a , b , c , d ) = \{ \begin{matrix}0 , & x < a \\ \frac{x - a}{b - a} , & a \leq x \leq b \\ 1 , & b \leq x \leq c \\ \frac{d - x}{d - c} , & c \leq x \leq d \\ 0 , & x \leq d\end{matrix} , \qquad ( 3 )$$

the input value x is a statistical value (for example, the value of lane crossing ratio, lane crossing change ratio, speed standard deviation, or close distance ratio), and a, b, c, d are parameters of the membership function that determine the shape and position of the trapezoidal membership function. In this membership function, when x<a and x≥d, the function value (that is, the value of the membership function or fuzzy value) is 0, indicating that in these ranges, the input value x is irrelevant to the trapezoidal membership function. When a≤x≤b, the function value gradually increases from 0 to 1, indicating that the membership increases linearly with the increase of x, and the membership (that is, the fuzzy value) is determined by (x−a)/(b−a). When b≤x≤c, the function value remains at 1, indicating that the membership of the input value x within this range (from the parameter b to the parameter c) is maximum. When c≤x<d, the function value gradually decreases from 1 to 0, indicating that the membership decreases linearly with the increase of the input value x, and the membership (that is, the fuzzy value) is determined by (d−x)/(d−c).

According to the above-mentioned trapezoidal membership function Formula (3) and FIG. 6A to FIG. 6D, an example is illustrated as follows.

TABLE 2

| | Statistical value (substitute | Membership (that is, fuzzy |
|---|---|---|
| Type of statistical value | the input value x) | value) |
| Lane crossing ratio | 30 | Mild: 0, moderate: 1, high: 0 |
| Lane crossing change ratio | 30 | Mild: 0, moderate: 1, high: 0 |
| Speed standard deviation | 5.3 | Mild: 0, moderate: (6 − 5.3)/(6 − |
| | | 5) = 0.7, high: (5.3 − 5)/(6 − 5) = |
| | | 0.3 |
| Close distance ratio | 48 | Mild: 0, moderate: (50 − |
| | | 48)/(50 − 40) = 0.2, high: (48 − |
| | | 40)/(50 − 40) = 0.8 |

Next, the processor 140 may determine that the fuzzy values of the behavior levels of the multiple pieces of vehicle behavior information correspond to a representative fuzzy value of the multiple warning levels. The processor 140 may pre-define the corresponding relationship between the behavior levels of the multiple pieces of vehicle behavior information and the instability information. The example is as follows.

TABLE 3

| Lane crossing | Lane crossing | Speed standard | Close distance | Instability |
|---|---|---|---|---|
| ratio | change ratio | deviation | ratio | information |
| Mild | Mild | Mild | Mild | No warning |
| Mild | Mild | Mild | Moderate | Mild warning |
| Mild | Mild | Mild | High | Mild warning |
| Moderate | Mild | Moderate | Mild | Moderate |
| | | | | warning |
| Moderate | Moderate | Moderate | Moderate | Moderate |
| | | | | warning |
| Moderate | Moderate | Moderate | High | High warning |
| Moderate | Moderate | High | Moderate | High warning |
| Moderate | Moderate | High | High | Extreme |
| | | | | warning |
| High | High | Moderate | High | Extreme |
| | | | | warning |
| High | High | High | High | Extreme |
| | | | | warning |
| . | . | . | . | . |
| . | . | . | . | . |
| . | . | . | . | . |

It is assumed that the warning levels of instability information include no warning, mild warning, moderate warning, high warning, and extreme warning. The warning level of no warning is the lowest, the warning level of mild warning is the second lowest, the warning level of high warning is the second highest, and the warning level of extreme warning is the highest.

The processor 140 may determine the instability information that matches the fuzzy values of behavior levels of the multiple pieces of vehicle behavior information. For example, taking Table (2) and Table (3) as examples, in Table (2), the lane crossing ratio corresponds to moderate (only the fuzzy value of moderate is greater than zero), the lane crossing change ratio corresponds to moderate (only the fuzzy value of moderate is greater than zero), the speed standard deviation corresponds to moderate and high (the fuzzy values of moderate and high are greater than zero), and the close distance ratio corresponds to moderate and high (the fuzzy values of moderate and high are greater than zero). Therefore, the fuzzy values obtained from Table (2) match the rules (that is, the corresponding relationship between behavior levels of the multiple pieces of vehicle behavior information and the instability information) in Table (3) as follows.

TABLE 4

| | Lane | Lane | Speed | Close | |
|---|---|---|---|---|---|
| Rule | crossing | crossing | standard | distance | Instability |
| number | ratio | change ratio | deviation | ratio | information |
| Rule 1 | Moderate | Moderate | Moderate | Moderate | Moderate |
| | | | | | warning |
| Rule 2 | Moderate | Moderate | Moderate | High | High warning |
| Rule 3 | Moderate | Moderate | High | Moderate | High warning |
| Rule 4 | Moderate | Moderate | High | High | Extreme |
| | | | | | warning |

In an embodiment, the processor 140 may determine the representative fuzzy value through the Max-min operation inference method. First, for the rules (that is, the corresponding relationship between behavior levels of the multiple pieces of vehicle behavior information and the instability information) that match one or more fuzzy values of behavior levels of the multiple pieces of vehicle behavior information, the processor 140 obtains the minimum value among the fuzzy values of behavior levels of the multiple pieces of vehicle behavior information that match the rules as the representative fuzzy value. For example, Table (3) is used as an example as follows.

$$Rule 1 : min ( 1 , 1 , 0.7 , 0.2 ) = 0.2 ( moderate warning ) .$$

$$Rule 2 : min ( 1 , 1 , 0.7 , 0.8 ) = 0.7 ( high warning ) .$$

$$Rule 3 : min ( 1 , 1 , 0.3 , 0.2 ) = 0.2 ( high warning ) .$$

$$Rule 4 : min ( 1 , 1 , 0.3 , 0.8 ) = 0.3 ( extreme warning ) .$$

Min( ) is a function that takes the minimum value (that is, minimum value operation). The input values in min( ) respectively represent the fuzzy values of behavior levels that match the rules. Taking Rule 1 as an example, in Table (2), the fuzzy value corresponding to moderate for lane crossing ratio is 1, the fuzzy value corresponding to moderate for lane crossing change ratio is 1, the fuzzy value corresponding to moderate for speed standard deviation is 0.7, and the fuzzy value corresponding to moderate for close distance ratio is 0.2. Therefore, by taking the minimum value of these fuzzy values, we obtain 0.2. The remaining rules may be deduced similarly, so details will not be repeated here.

Next, in response to the multiple pieces of vehicle behavior information matching multiple pieces of instability information, the processor 140 takes the maximum value among multiple representative fuzzy values of the same warning level as the (final) representative fuzzy value for this warning level. For example, in Table (4), since there are two rules with instability information as high warning, the processor 140 uses the maximum value operation to determine the (final) representative fuzzy value:

$$Max ( 0.7 , 0.2 ) = 0.7 ( high warning ) .$$

Max( ) is a function that takes the maximum value (that is, maximum value operation). The input values in Max( ) respectively represent the representative fuzzy values corresponding to high warning obtained through the minimum value operation mentioned above. Therefore, 0.7 is finally chosen as the representative fuzzy value for high warning:
Representative fuzzy value for moderate warning: 0.2.
Representative fuzzy value for high warning: 0.7.
Representative fuzzy value for extreme warning: 0.3.

Next, the processor 140 converts the representative fuzzy value of the multiple warning levels into a single warning level (for example, the second level among multiple warning levels, and the second level may be moderate, high, or extreme) through defuzzification. Defuzzification is used to derive a specific value (for example, an instability score in the instability information) from a fuzzy set formed by representative fuzzy values of multiple types, to be used for subsequent decision-making or control. Defuzzification may be, for example, the center average method:

$$y *= \frac{{\sum }_{j = 1}^{J} ( {\overline{y}}^{j} * {μ}_{{c}^{j}} ( {\overline{y}}^{j} ) )}{{\sum }_{j = 1}^{J} {μ}_{{c}^{j}} ( {\overline{y}}^{j} )} , \qquad ( 4 )$$

J is the total number of activated rules, y̅^{j} is the center position of the fuzzy output, and μ_{c}_{^{j}}(y̅^{j}) is the membership (that is, representative fuzzy value) inferred by fuzzy reasoning.

For example, the processor 140 may pre-define the center position for each warning level (that is, the center position of the fuzzy output) as follows.
No warning: 10.
Mild warning: 30.
Moderate warning: 50.
High warning: 70.
Extreme warning: 90.
   The representative fuzzy value may be substituted into the Formula (4) to obtain the instability score:

$$( ( 0.2 * 50 ) + ( 0.7 * 70 ) + ( 0.3 * 90 ) ) / ( 0.2 + 0.7 + 0 \text{.3} )$$

$$= ( 10 + 49 + 27 ) / 1.2$$

$$= 71. 67 .$$

In other words, the instability score may be obtained by using the center position of each warning level as a weight, and determining the weighted average of the representative fuzzy values of multiple warning levels. For example, the product of the representative fuzzy value of the moderate warning and the center position thereof (0.2*50), the product of the representative fuzzy value of the high warning and the center position thereof (0.7*70), and the product of the representative value of the extreme warning and the center position thereof (0.3*90) are summed (10+49+27) and then divided by the sum of the center positions of moderate warning, high warning, and extreme warning (0.2+0.7+0.3) to obtain the value (71.67).

The processor 140 may determine between which warning level center positions the instability score falls, and accordingly determine the instability information corresponding to the instability score. For example, when the instability score is 71.67, 71.67 is greater than the center position of high warning but less than the center position of extreme warning (that is, between the center positions of high warning and extreme warning), the instability information for this instability score belongs to “high warning”.

In an embodiment, the processor 140 may output warning information through the output device 120. For example, the processor 140 may use vehicle status information, behavioral intention information, and/or instability information as the output warning information. Depending on the application scenario, the processor 140 may select the type of output device 120 as follows. For example, the type may be displaying visual warning information through the screen of the display 121, presenting visual warning information by flashing or steady illumination of the warning light 122 (for example, hazard indicator light), playing auditory warning information through the speaker 123, and/or remotely reporting warning information to other devices through the communication transceiver 124.

For the warning output of vehicle status information, one of the multiple purposes is to remind the driver about potential accident risks that may exist with surrounding vehicles, and to help the driver perform defensive driving in advance, thereby protecting their own safety. Therefore, the output device 120 may issue a brief warning behavior for the vehicle conditions of surrounding vehicles. For example, the in-vehicle display may show a prompt icon in the edge area, or the speaker may emit a brief sound.

For the warning output of behavioral intention information, one of the multiple purposes is to remind the driver about vehicles with detected malicious behavior and that immediate responsive actions should be taken. Therefore, the output device 120 may issue a continuous and significant warning behavior. For example, the in-vehicle display may display a prominent icon corresponding to the warning information and continuously flash the icon, the red warning light may flash, the speaker may emit an urgent sound, or remote reporting may be initiated.

For the warning output of instability information, one of the multiple purposes is to remind the driver about potential accident risks that may exist with surrounding vehicles. For example, based on the quantitative characteristics of the instability score, possible warning output schemes are listed as follows.

TABLE 5

| Range of | | | | | | | |
|---|---|---|---|---|---|---|---|
| instability | Warning | Color | Warning | Warning | | Frequency | |
| score | level | classification | times | interval | Volume | sharpness | Annotation |
| <20 | No | Green | None | None | None | None | Normal |
| | warning | | | | | | |
| 20-40 | Mild | Yellow | 1 time | 3 | 10% | Mild | |
| | warning | | | seconds | | | |
| 40-60 | Moderate | Orange | 2 times | 2 | 50% | Moderate | |
| | warning | | | seconds | | | |
| 60-80 | High | Red | 3 times | 1 second | 75% | Intense | |
| | warning | | | | | | |
| >80 | Extreme | Red | Continuous | 0.5 | 100% | Very | |
| | warning | exclamation | warning | second | | intense | |
| | | mark | | | | | |

In an embodiment, the processor 140 may present a warning image corresponding to the warning information in an image area through the display 121. The warning image may include text, icons/patterns, or combinations thereof. This image area corresponds to an area of the neighboring vehicle being on a windshield of the vehicle or an area of the neighboring vehicle being in an environmental image. Augmented Reality (AR) may combine virtual warning images with real-world scenes. The display 121 may project the warning image onto the windshield. Since the warning information is related to the behavior of the neighboring vehicle, corresponding the image area (that is, the display area of the warning image) of the warning image to the position (that is, the area on the windshield where the neighboring vehicle is seen from the perspective of the driver) in the real-world scene helps in understanding which neighboring vehicle the warning information corresponds to. Alternatively, the processor 140 may combine the warning image with the environmental image. For example, the processor 140 may detect the neighboring vehicle and the position thereof (the area corresponding to the position may be defined using a Region of Interest (ROI) or bounding box) in the environmental image captured by the image capture device 111, and overlay or merge the warning image near the area of the neighboring vehicle in the environmental image or within the area of the neighboring vehicle in the environmental image.

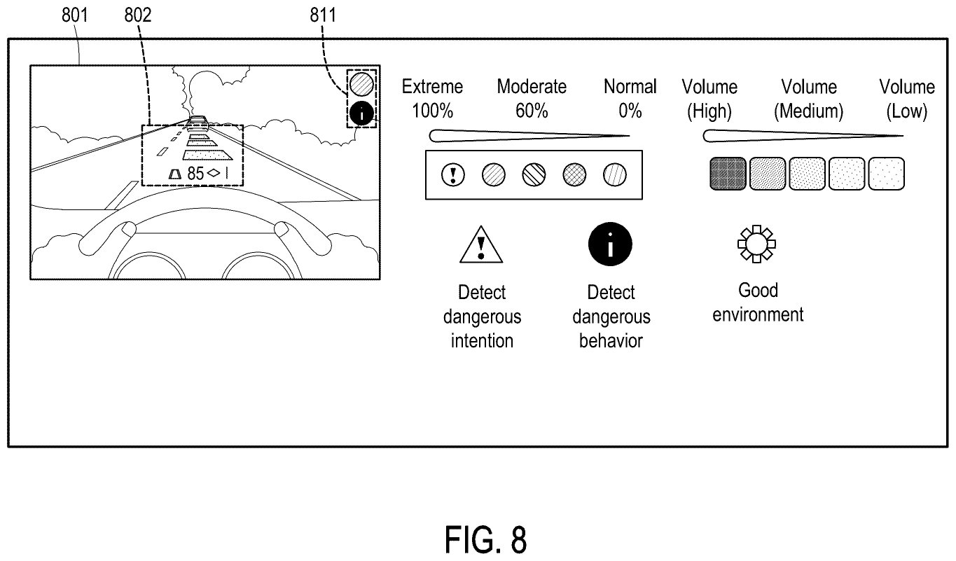

For example, FIG. 8 is a schematic diagram illustrating a warning image 811 for continuous lane changing according to an embodiment of the disclosure. Referring to FIG. 8, assuming that the processor 140 discovers that the vehicle behavior information of the vehicle ahead is continuous lane changing, and the instability score is 71.67. The display 121 (for example, a head-up display) may project an image onto the windshield 801, causing the windshield 801 to present driver assistance information 802 and the warning image 811. The driver assistance information 802 may include, for example, vehicle speed information (as “85” shown in the drawing) and vehicle distance information (as shown by the three distance unit blocks) related to an adaptive cruise control system. For the sake of a clean display, the display 121 may not show the instability score. In the warning image 811, the topmost reminder icon may be a red icon corresponding to the instability score, and immediately adjacent to the topmost reminder icon is a simple schematic diagram of the hazardous intention or vehicle behavior information. The reminder icon provides a simple and intuitive warning output without displaying detailed event content. In addition, the speaker 123 may also emit a very loud and sharp sound.

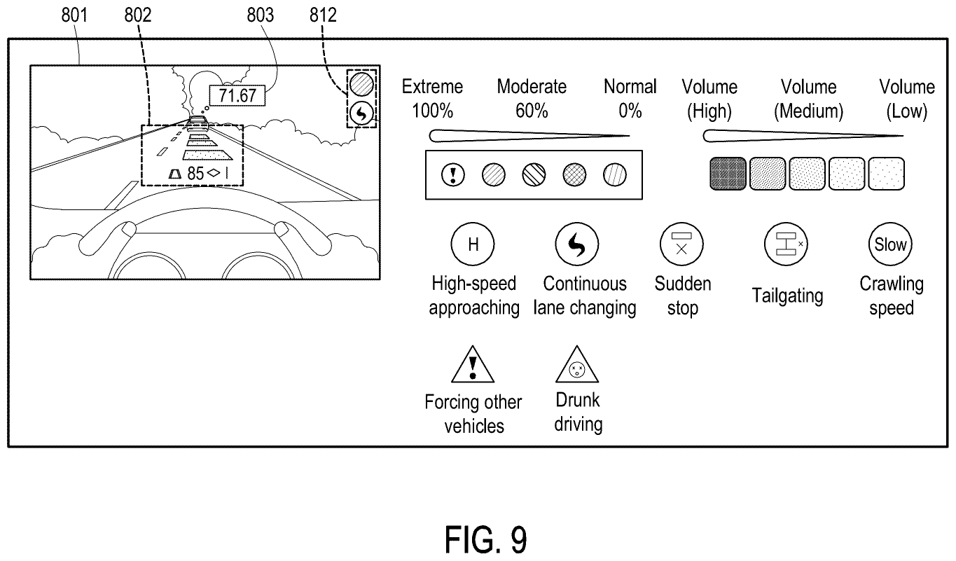

FIG. 9 is a schematic diagram illustrating warning images 803 and 812 for continuous lane changing according to an embodiment of the disclosure. Referring to FIG. 9, compared to the prompting method in FIG. 8, a more advanced prompting method may be provided. The windshield 801 further presents the warning image 803 related to the instability score (as “71.67” shown in the drawing). The image area of the warning image 803 is positioned above the position where the neighboring vehicle appears on the windshield 801. Furthermore, the reminder icon for “continuous lane changing” in the warning image 812 is a simplified diagram of the event content.

It should be noted that FIG. 8 and FIG. 9 are merely example illustrations for a specific application scenario, and the content and position of the warning images may still be modified according to actual needs.

In summary, in the warning method and the warning system for vehicle driving according to the embodiments of the disclosure, vehicle information related to neighboring vehicles is converted into vehicle characteristics, and warning information corresponding to the statistical values accumulated for vehicle characteristics meeting hazard conditions is generated. In this way, the behavior, intention, and/or instability of surrounding vehicles (that is, neighboring vehicles) may be evaluated, and accordingly, whether the neighboring vehicles are hazardous driving vehicles can be assessed. Furthermore, by prompting the warning information, drivers may be helped to notice hazardous driving vehicles, allowing the drivers to respond to dangerous behaviors as quickly as possible, thereby the driving safety is improved.

Although the disclosure has been disclosed by the foregoing embodiments, the embodiments are not intended to limit the disclosure. Persons skilled in the art may make some changes and modifications without departing from the spirit and scope of the disclosure. Therefore, the protection scope of the disclosure should be defined by the appended claims.

What is claimed is:

1. A warning method for vehicle driving, comprising:
obtaining vehicle information, wherein the vehicle information is obtained by detecting a neighboring vehicle surrounding a vehicle;
converting the vehicle information into at least one vehicle characteristic, wherein the at least one vehicle characteristic represents a relative relationship between the vehicle and the neighboring vehicle;
determining a statistical value corresponding to the at least one vehicle characteristic, wherein the statistical value is accumulated in response to the at least one vehicle characteristic meeting corresponding hazard conditions; and
generating warning information based on the statistical value, wherein the warning information is configured to indicate the relative relationship between the vehicle and the neighboring vehicle.

2. The warning method for vehicle driving as claimed in claim 1, wherein determining the statistical value corresponding to the at least one vehicle characteristic comprises:
counting the number of times the at least one vehicle characteristic meeting the corresponding hazard conditions at a plurality of observation time points, wherein a ratio of the number of times to the observation time points serves as the statistical value corresponding to the at least one vehicle characteristic.

3. The warning method for vehicle driving as claimed in claim 1, wherein the hazard conditions comprise at least one of the neighboring vehicle being on a road line, the neighboring vehicle being not on the road line, the neighboring vehicle crossing the road line, the neighboring vehicle being within a safe distance range, the neighboring vehicle being outside the safe distance range, and a difference between a target speed corresponding to the neighboring vehicle and an average speed.

4. The warning method for vehicle driving as claimed in claim 1, wherein generating the warning information based on the statistical value comprises:
determining vehicle behavior information of the neighboring vehicle based on the statistical value, wherein the vehicle behavior information comprises at least one of a plurality of behavior levels corresponding to the hazard conditions, and the behavior levels comprise a first level; and
determining the corresponding warning information based on the at least one vehicle characteristic and the first level corresponding to the vehicle behavior information.

5. The warning method for vehicle driving as claimed in claim 4, wherein the warning information comprises vehicle status information, and determining the corresponding warning information based on the at least one vehicle characteristic and one of the behavior levels corresponding to the vehicle behavior information comprises:
determining the vehicle status information of the neighboring vehicle based on the at least one vehicle characteristic and one of the behavior levels corresponding to the vehicle behavior information.

6. The warning method for vehicle driving as claimed in claim 5, wherein the vehicle status information comprises at least one of tailgating, high-speed approaching, sudden deceleration, speed fluctuation, continuous change of driving path, lane crossing driving, close distance lane changing, and path fluctuation.

7. The warning method for vehicle driving as claimed in claim 5, wherein the warning information comprises behavioral intention information, the relative relationship comprises a vehicle distance, and the warning method further comprises:
determining the behavioral intention information of the neighboring vehicle based on a vehicle distance characteristic among the at least one vehicle characteristic and the vehicle status information of the neighboring vehicle, wherein the vehicle behavior information corresponding to the vehicle distance characteristic indicates a behavior intensity of the vehicle distance, and the behavioral intention information comprises at least one of forcing front vehicle behavioral intention and forcing rear vehicle behavioral intention.

8. The warning method for vehicle driving as claimed in claim 4, wherein the warning information comprises instability information, and the warning method further comprises:
determining the instability information of the neighboring vehicle based on the behavior levels of a plurality of pieces of vehicle behavior information, wherein the instability information comprises a plurality of warning levels.

9. The warning method for vehicle driving as claimed in claim 8, wherein determining the instability information of the neighboring vehicle based on the behavior levels of the plurality of pieces of vehicle behavior information comprises:
converting the behavior levels of the plurality of pieces of vehicle behavior information into fuzzy values of the behavior levels of the plurality of pieces of vehicle behavior information through corresponding membership functions, wherein each of the membership functions matches a fuzzy rule of each piece of the vehicle behavior information;
determining that the fuzzy values of the behavior levels of the plurality of pieces of vehicle behavior information correspond to a representative fuzzy value of the warning levels, wherein the warning levels comprise a second level; and
converting the representative fuzzy value of the warning levels into the second level through defuzzification.

10. The warning method for vehicle driving as claimed in claim 1, further comprising:
presenting a warning image corresponding to the warning information in an image area, wherein the image area corresponds to an area of the neighboring vehicle being on a windshield of the vehicle or an area of the neighboring vehicle being in an environmental image.

11. A warning system for vehicle driving, comprising:
a storage device storing a program code; and
a processor coupled to the storage device, and loading and executing the program code to:
obtain vehicle information, wherein the vehicle information is obtained by detecting a neighboring vehicle surrounding a vehicle;
convert the vehicle information into at least one vehicle characteristic, wherein the at least one vehicle characteristic represents a relative relationship between the vehicle and the neighboring vehicle;
determine a statistical value corresponding to the at least one vehicle characteristic, wherein the statistical value is accumulated in response to the at least one vehicle characteristic meeting corresponding hazard conditions; and
generate warning information based on the statistical value, wherein the warning information is configured to indicate the relative relationship between the vehicle and the neighboring vehicle.

12. The warning system for vehicle driving as claimed in claim 11, wherein the processor further executes:
counting the number of times the at least one vehicle characteristic meeting the corresponding hazard conditions at a plurality of observation time points, wherein a ratio of the number of times to the observation time points serves as the statistical value corresponding to the at least one vehicle characteristic.

13. The warning system for vehicle driving as claimed in claim 11, wherein the hazard conditions comprise at least one of the neighboring vehicle being on a road line, the neighboring vehicle being not on the road line, the neighboring vehicle crossing the road line, the neighboring vehicle being within a safe distance range, the neighboring vehicle being outside the safe distance range, and a difference between a target speed corresponding to the neighboring vehicle and an average speed.

14. The warning system for vehicle driving as claimed in claim 11, wherein the processor further executes:
determining vehicle behavior information of the neighboring vehicle based on the statistical value, wherein the vehicle behavior information comprises at least one of a plurality of behavior levels corresponding to the hazard conditions, and the behavior levels comprise a first level; and
determining the corresponding warning information based on the at least one vehicle characteristic and the first level corresponding to the vehicle behavior information.

15. The warning system for vehicle driving as claimed in claim 14, wherein the warning information comprises vehicle status information, and the processor further executes:
determining the vehicle status information of the neighboring vehicle based on the at least one vehicle characteristic and one of the behavior levels corresponding to the vehicle behavior information.

16. The warning system for vehicle driving as claimed in claim 15, wherein the vehicle status information comprises at least one of tailgating, high-speed approaching, sudden deceleration, speed fluctuation, continuous change of driving path, lane crossing driving, close distance lane changing, and path fluctuation.

17. The warning system for vehicle driving as claimed in claim 15, wherein the warning information comprises behavioral intention information, the relative relationship comprises a vehicle distance, and the processor further executes:
determining the behavioral intention information of the neighboring vehicle based on a vehicle distance characteristic among the at least one vehicle characteristic and the vehicle status information of the neighboring vehicle, wherein the vehicle behavior information corresponding to the vehicle distance characteristic indicates a behavior intensity of the vehicle distance, and the behavioral intention information comprises at least one of forcing front vehicle behavioral intention and forcing rear vehicle behavioral intention.

18. The warning system for vehicle driving as claimed in claim 14, wherein the warning information comprises instability information, and the processor further executes:
determining the instability information of the neighboring vehicle based on the behavior levels of a plurality of pieces of vehicle behavior information, wherein the instability information comprises a plurality of warning levels.

19. The warning system for vehicle driving as claimed in claim 18, wherein the processor further executes:
converting the behavior levels of the plurality of pieces of vehicle behavior information into fuzzy values of the behavior levels of the plurality of pieces of vehicle behavior information through corresponding membership functions, wherein each of the membership functions matches a fuzzy rule of each piece of the vehicle behavior information;
determining that the fuzzy values of the behavior levels of the plurality of pieces of vehicle behavior information correspond to a representative fuzzy value of the warning levels, wherein the warning levels comprise a second level; and
converting the representative fuzzy value of the warning levels into the second level through defuzzification.

20. The warning system for vehicle driving as claimed in claim 11, further comprising a display, wherein the processor further executes:
presenting a warning image corresponding to the warning information through the display in an image area, wherein the image area corresponds to an area of the neighboring vehicle being on a windshield of the vehicle or an area of the neighboring vehicle being in an environmental image.
